(19) United States
(12) Patent Application Publication
(10) Pub. No.: US 2010/0188251 A1
(43) Pub. Date: Jul. 29, 2010

(54) APPARATUS AND METHOD FOR AN AC WIRELESS SWITCH

(76) Inventor: Donald G. Panuce, Sarasota, FL (US)

Correspondence Address: MILLER, MATTHIAS & HULL, ONE NORTH FRANKLIN STREET, SUITE 2350, CHICAGO, IL, 60606, US

(21) Appl. No.: 12/691,872

(22) Filed: Jan. 22, 2010

Related U.S. Application Data
(60) Provisional application No. 61/146,730, filed on Jan. 23, 2009.

(51) Int. Cl. G05B 19/02

(52) U.S. Cl. 340/825.22

(57) ABSTRACT

An apparatus and method for using an AC wireless switch is disclosed. The AC wireless switch may include an AC powered transmitter capable of transmitting signals wirelessly, an AC powered receiver capable of receiving signals wirelessly, and at least one switch in electrical communication with the transmitter and capable of providing a signal to the transmitter, indicating the activation and deactivation of a device and/or the transmitter. The method for wirelessly switching an AC powered device using the AC wireless switch, comprises the steps of: transmitting a first signal to activate the transmitter, requesting to activate the AC powered device, transmitting a second signal from the transmitter to the receiver wirelessly, receiving the second signal by the receiver, and enabling AC power to activate the AC powered device. The AC wireless switch may be also capable of disabling power to the AC powered device upon the request to deactivate the AC power device.

### FIELD OF THE DISCLOSURE

The present disclosure generally relates to a switch and, in particular, relates to an apparatus and method for using a wireless alternating current (AC) switch.

### BACKGROUND OF THE DISCLOSURE

Switches are widely used in applications were a circuit needs to be interrupted in order to change a given state. For example, switches are commonly used in changing the state of a light fixture from off to on, and vice versa. A switch is composed of a set of contacts that indicate whether the switch is open, i.e. no electrical contact, or closed, i.e. electrical contact exists. In one exemplary application, one contact of the switch is wired to a power source, while the other contact of the switch is wired to a device, such as a light fixture. Usually, light fixtures operate with an AC power source obtained from a building structure, but may be operated with a direct current (DC) power source. A light switch is wired to be normally open, i.e. no electrical contact, light fixture in off state. In the off state, the circuit connecting the AC power source to the light fixture is interrupted. As the light switch is activated to turn the light fixture on, the contacts in the light switch are closed, i.e. make electrical contact, thus closing the circuit, which provides AC power to the light fixture.

The conventional method of hardwiring a switch to interrupt power to a device provides a number of disadvantages. One disadvantage is wiring constraints. The distance between the power source, the switch, and the device is determined by the length of the wire. Exposed wire can create an electrical hazard, and is usually concealed within building walls or in enclosed casing. The concealment of wire makes any type of upgrade and/or modification to the circuit extremely difficult. Also, hardwiring creates a location limitation of where the switch can be installed relative to the power source and the device. Attempts have been made to provide a wireless switch to control devices in order to eliminate the need for hardwiring.

One attempt in providing a wireless switch is the commercially well known product called the “Handy Switch”. The Handy Switch enables wireless switching with the use of a transmitter and receiver. The light switch includes a transmitter to transmit over the air a signal to the receiver, which may be connected to a light fixture, requesting a change in state. While the receiver is powered by the same power source as the light fixture, which is commonly an AC power source, the transmitter is battery operated, which is a DC power source. DC powered transmitters have a few disadvantages. For instance, battery operated transmitters are unreliable due to the short life expectancies of batteries. The batteries in a transmitter must be continuously replaced. Another disadvantage of a DC powered transmitter is the limited voltage range. A device operating in DC mode is limited to lower voltage ranges, while AC operation allows for much higher voltage ranges. Furthermore, since AC power is commonly used in building structures, devices that operate with DC power need an AC-to-DC converter.

In light of the foregoing, a need for an AC wireless switch continues to be sought.

### SUMMARY OF THE DISCLOSURE

In accordance with one aspect of the disclosure, an AC wireless switch is provided that includes a transmitter powered by an AC power source, capable of transmitting signals wirelessly; a receiver powered by an AC power source, capable of receiving signals wirelessly; and at least one switch in electrical communication with the transmitter and capable of providing a signal to the transmitter, indicating the activation and deactivation of a device and/or the transmitter.

In accordance with another aspect of the disclosure, a method is disclosed for wirelessly switching an AC powered device using the AC wireless switch, comprising the steps of: transmitting a first signal to activate the transmitter; requesting to activate the AC powered device; transmitting a second signal from the transmitter to the receiver wirelessly; receiving the second signal by the receiver; and enabling AC power to activate the AC powered device.

Other advantages and features will be apparent from the following detailed description when read in conjunction with the attached drawings.

### BRIEF DESCRIPTION OF THE DRAWINGS

For a more complete understanding of the disclosed system and method, reference should be made to the embodiments illustrated in greater detail in the accompanying drawings, wherein:

FIG. 1 is a block diagram of an embodiment of an AC wireless switch constructed in accordance with the teachings of the present disclosure;

FIG. 2 is a schematic of an embodiment of a transmitter constructed in accordance with the teachings of the present disclosure;

FIG. 3 is a schematic of an embodiment of a receiver constructed in accordance with the teachings of the present disclosure;

FIG. 4 is a flowchart depicting a sample sequence of steps which may be practiced in accordance with the method of the present disclosure.

It should be understood that the drawings are not necessarily to scale and that the disclosed embodiments are sometimes illustrated diagrammatically and in partial views. In certain instances, details which are not necessary for an understanding of the disclosed methods and systems or which render other details difficult to perceive may have been omitted. It should be understood, of course, that this disclosure is not limited to the particular embodiments illustrated herein.

### DETAILED DESCRIPTION OF THE DISCLOSURE

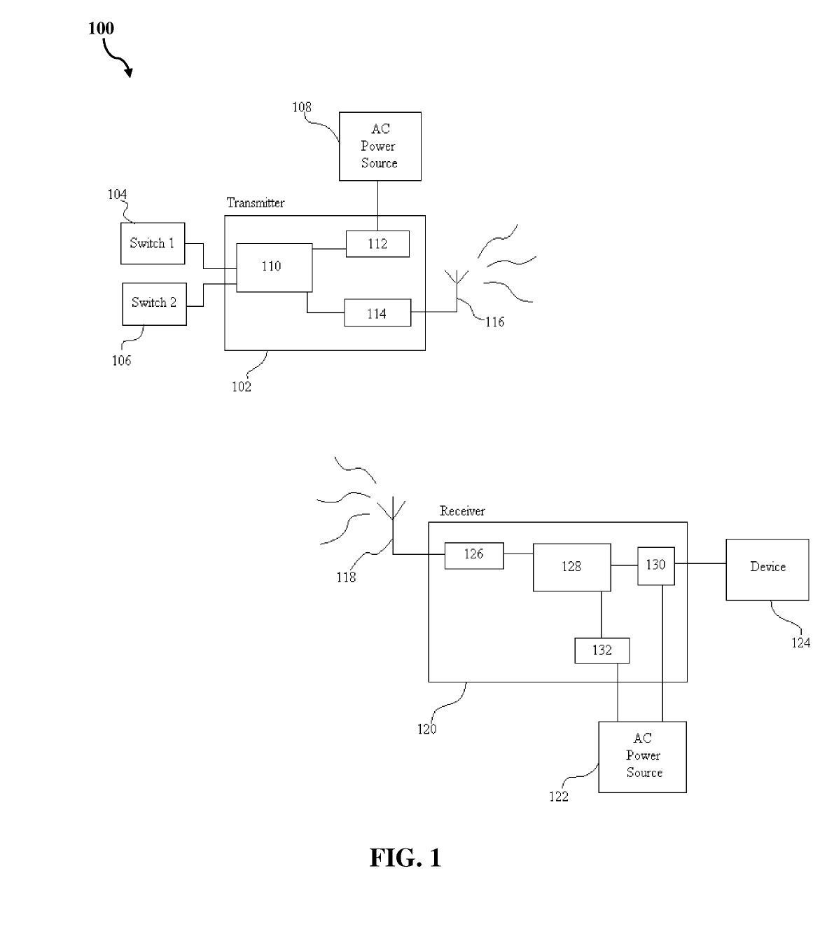

Referring to FIG. 1, an AC wireless switch 100 which may be operated according to the principles of the present disclosure is illustrated. The AC wireless switch 100 may include at least one switch 104 in electrical communication with a transmitter 102. The transmitter may be powered by an AC power source 108. In one exemplary embodiment, the AC power source 108 may be a single-phase power source, voltage ranging from 90 to 285 VAC, or a three-phase power source, voltage ranging from 185 to 600 VAC. Furthermore, it is to be understood that the AC power source 108 may not be limited to single-phase or three-phase, but may incorporate any other type of an AC power source.

The transmitter 102 may have a means for converting analog power out of the AC power source 108 to digital power in order to power a controller 110, which may be contained within the transmitter 102 and may be DC operated. In one exemplary embodiment, the means for converting analog power to digital power may be performed by an analog-to-digital convertor (ADC) 112. Once the ADC 112 has converted the power to DC, the controller 110 may be powered. In one exemplary embodiment, the controller 110 may be a microcontroller. It is to be understood that the controller 110 may not be limited to a microcontroller, but may incorporate any other type of controller capable of processing signals and controlling devices.

In one exemplary embodiment the switch 104 may be hardwired to the transmitter 102. However, it is to be understood that the switch 104 may not be limited to being hardwired, but may incorporate any other form of electrical communication such as wireless communication over the air, over Bluetooth standards, and any other form of wireless communication with the use of a key fob, or any other device capable of wireless communication. The switch 104 may include metal contact points wherein the open state may be defined as the contact points not making electrically contact, i.e. circuit may be interrupted disabling current flow, and the closed state may be defined as the contact points making electrical contact, i.e. circuit may be complete allowing current flow. In one exemplary embodiment the switch 104 may be a push-button switch wherein the contact points may be normally open until the switch may be activated, causing the contact points to close, which may complete the circuit and may allow current to flow through the circuit. Furthermore, it is to be understood that the switch 104 may not be limited to a push-button switch, but may include any other type of switch capable of activating and deactivating a device, such as a toggle switch, pressure switch, and logic switch.

In one exemplary embodiment, the switch 104 may activate and deactivate the transmitter 102, while at the same time it may activate and deactivate a request to turn on a device 124. For example, when the switch 104 may be normally open, the transmitter 102 may be deactivated, i.e. in an off state, thus incapable of transmitting signals requesting to turn on the device 124. Once the switch 104 is activated, the transmitter 102 may turn on and may start transmitting signals, requesting to turn on the device 124. Thus, one switch 104 may be capable of activating the transmitter 102 and requesting to activate the device 124. In another exemplary embodiment, the switch 104 may activate the transmitter 102, while another switch 106 may request activating the device 124. In one exemplary embodiment, the switch 106 may be, but not limited to, a push-button switch which may be normally open. Furthermore, it is to be understood that the switch 106 may be capable of sending signals wirelessly as described with switch 104 previously.

Once the transmitter 102 is turned on and the switch 106 sends a signal requesting to turn on the device 124, the signal may be sent to the controller 110, which may be capable of processing the signal received from the switch 106. The transmitter 102 also may have a means for converting digital signals out of the controller 110 to analog signals to be transmitted over the air with an antenna 116. In one exemplary embodiment, the means for converting digital signals to analog signals may be performed by a digital-to-analog convertor (DAC) 114. Once the DAC 114 has converted a second signal out of the controller 110 to analog, the second signal may be transmitted over the air using a frequency range. In one exemplary embodiment, the frequency range may be, but not limited to, 339 to 341 MHz. It is to be understood that other frequency ranges may be possible.

The AC wireless switch also may contain a receiver 120. The receiver 120 may also have an antenna 118 and may be powered by an AC power source 122. In one exemplary embodiment, the same AC power source 122 which may power the receiver 102, also may power the device 124. The AC power source 122 may be a single-phase power source, voltage ranging from 90 to 285 VAC, or a three-phase power source, voltage ranging from 185 to 600 VAC. Furthermore, it is to be understood that the AC power source 122 may not be limited to single-phase or three-phase, but may incorporate any other type of an AC power source.

The receiver 120 may have a means for converting analog power out of the AC power source 122 to digital power in order to power a controller 128, which may be contained within the receiver 120 and may be DC operated. In one exemplary embodiment, the means for converting analog power to digital power may be performed by an analog-to-digital convertor (ADC) 132. Once the ADC 132 has converted the power to DC, the controller 128 may be powered. In one exemplary embodiment, the controller 128 may be a microcontroller. It is to be understood that the controller 128 may not be limited to a microcontroller, but may incorporate any other type of controller capable of processing signals and controlling devices.

The receiver 120 may be paired to receive the second signal from the transmitter 102 by having a similar receiving frequency range. In one exemplary embodiment, the receiving frequency range may be between 338 to 342 MHz. It is to be understood, that other frequency ranges may be possible in order to receive the second signal. Once the antenna 118 receives the second signal, the receiver may have a means to convert analog signals received to digital signals in order for the controller 128 to process the second signal. In one exemplary embodiment, the means for converting analog signals to digital signals may be performed by an analog-to-digital convertor (ADC) 126. Once the ADC 126 has converted the second signal to digital, the controller 128 may process the second signal and may turn on the device 124 through a switch 130.

In one exemplary embodiment, the switch may be, but not limited to, an electromagnetic relay. The switch 130 may have one contact point connected to the AC power source 122 and the other contact point may be connected to the device 124. Once the controller 128 activates the switch 130, the switch 130 may close the circuit, allowing AC power to the device 124, thus activating the device 124. In one exemplary embodiment, the device 124 may be, but not limited to, an exhaust fan, supply fan, ventilation fan, air circulating fan, blower, ceiling fan, and kitchen ventilation fan. In another exemplary embodiment, the device 124 may be, but not limited to, a powered damper, liquid pump, gas pump, air pump, hydraulic pump, pneumatic pump, and chemical pump. In yet another exemplary embodiment, the device 124 may be, but not limited to, an interior building light, exterior building light, street and highway light, landscape light, security light, parking lot and area light, emergency light, and boat and ship dock light. In yet another exemplary embodiment, the device 124 may be, but not limited to, a horn, siren, aerator for lakes and ponds, driveway heater, heater in industrial, commercial, farm, and residential buildings, and any other heater or cooling unit. In yet another exemplary embodiment, the device 124 may be, but not limited to, a dock leveler for industrial and commercial buildings, hoist, lift, elevator, man lift, auto and truck lift, boat lift, boat hoist, and conveyor used for industrial, agricultural, construction, and manufacturing assembly lines. In yet another exemplary embodiment, the device 124 may be, but not limited to, an irrigation device, water pump, feed conveyor, grain elevator, milking parlor, and any other agricultural device. In yet another exemplary embodiment, the device 124 may be, but not limited to, a motor/power operated shutter for windows and doors, airplane hanger door, powered curtain, shade, drape used in residential, commercial and industrial applications, device for lifting, lowering, opening, and closing scenery in theaters of all types, and retractable screen for movie theaters, homes, offices, and any other type of displays.

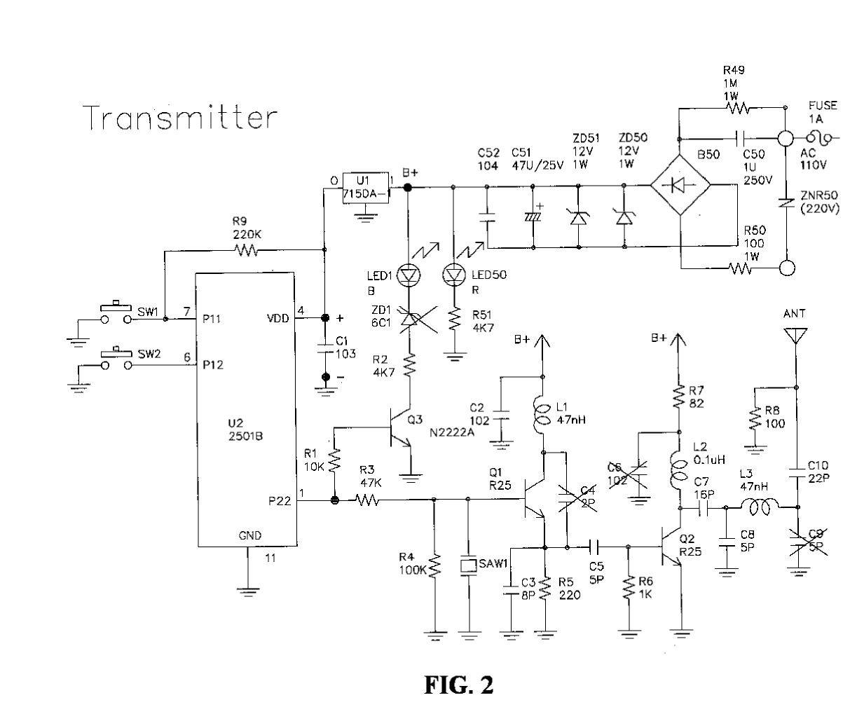

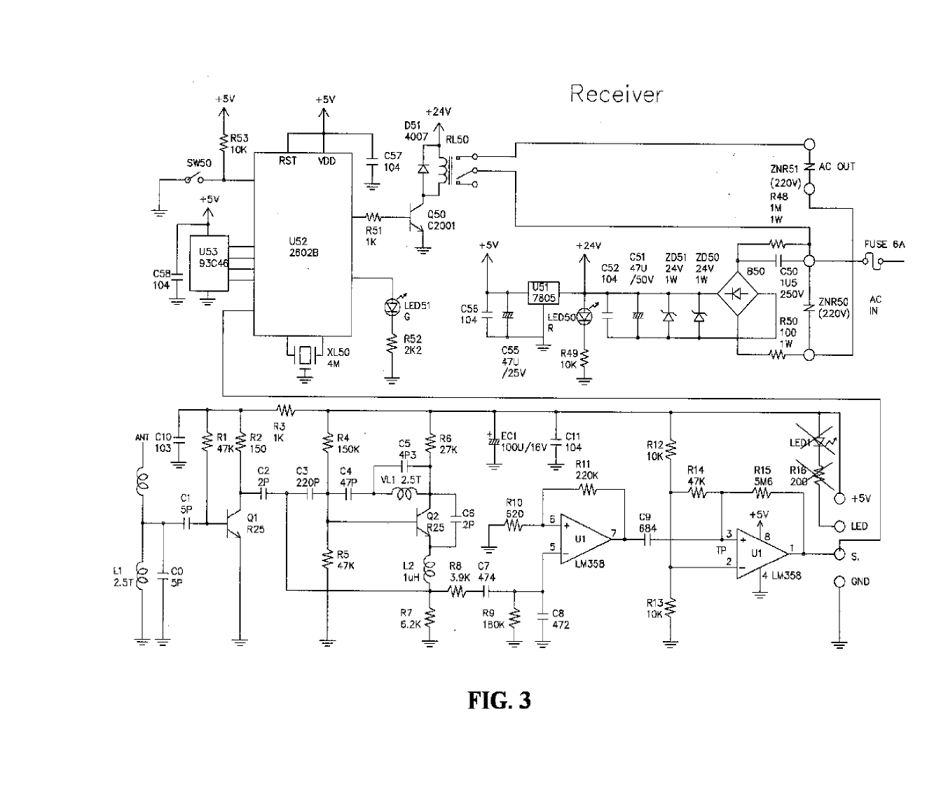

Referring now to FIGS. 2 and 3, a schematic representation of the transmitter 102 and receiver 120 is disclosed. In FIGS. 2 and 3, the schematics show electrical components that may be used in designing the AC wireless switch 100. It is to be understood that the schematics disclosed in FIGS. 2 and 3 may be exemplary embodiments of the AC wireless switch 100, and that other embodiments may be possible.

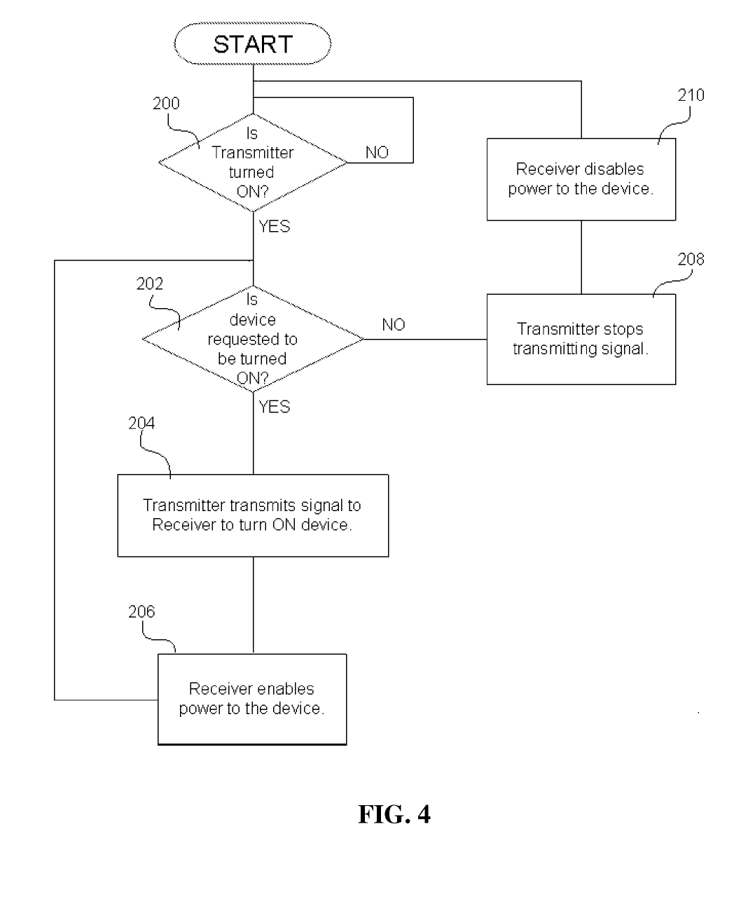

Referring now to FIG. 4, a method for operating the AC wireless switch 100 is disclosed in the form of a flowchart. In FIG. 4, step 200 represents checking to see if the transmitter 102 is powered on. If the transmitter is powered on, the following step 202, represents querying to see if a request to turn on the device 124 has been made. The request to turn on the device 124 may be made by receiving a first signal from the switch 106. If a request to turn on the device 124 is made, then in step 204, the transmitter 102 may transmit a second signal to the receiver 120 to turn on the device 124. In step 206, the receiver may activate the switch 130, enabling AC power to be delivered to the device 124, thus turning on the device 124. Once the device 124 is powered on in step 206, the system may return back to step 202, querying the request to turn the device 124 on.

Returning now to step 202, if the request to turn on the device discontinues, i.e. the switch 106 sends the signal to deactivate the device 124, then in step 208, the transmitter 102 may stop transmitting the second signal to the receiver 120. In step 210, the receiver 120 may disable power to the device 124 by deactivating the switch 130. The system then may return back to step 200, wherein it checks to see if the transmitter is still active. The manual deactivation of the transmitter 102 may be performed by switch 104. Upon the manual deactivation of the transmitter 102, the transmitter 102 may stop transmitting the second signal, and the system may return back to step 200 until the transmitter 102 is activated.

While only certain embodiments have been set forth, alternatives and modifications will be apparent from the above description to those skilled in the art. These and other alternatives are considered equivalents and within the spirit and scope of this disclosure and the appended claims.

What is claimed is:

1. An AC wireless switch, comprising:
a transmitter powered by an AC power source and capable of transmitting signals wirelessly;
a receiver powered by an AC power source and capable of receiving signals wirelessly; and
at least one switch in electrical communication with the transmitter and capable of providing a signal to the transmitter, the signal indicating the activation and deactivation one of a device and the transmitter.

2) The AC wireless switch of claim 1, wherein the transmitter includes a controller, an analog-to-digital converter, a digital-to-analog converter, and an antenna.

3) The AC wireless switch of claim 1, wherein the receiver includes at least one analog-to-digital converter, an antenna, and a switch electrically connecting the AC power source to the device.

4) The AC wireless switch of claim 1, wherein the at least one switch is normally open.

5) The AC wireless switch of claim 1, wherein the at least one switch is remotely located and capable of transmitting signals wirelessly to the transmitter.

6) The AC wireless switch of claim 1, wherein the at least one switch indicates the activation and deactivation of the transmitter, while a second switch indicates the activation and deactivation of the device.

7) The AC wireless switch of claim 3, wherein the switch in the receiver is an electromagnetic relay.

8) The AC wireless switch of claim 1, wherein the device is selected from the group consisting of an exhaust fan, supply fan, ventilation fan, air circulating fan, blower, ceiling fan, kitchen ventilation fan, powered damper, liquid pump, gas pump, air pump, hydraulic pump, pneumatic pump, chemical pump, interior building light, exterior building light, street and highway light, landscape light, security light, parking lot and area light, emergency light, boat and ship dock light, horn, siren, aerator for lakes and ponds, driveway heater, heater in industrial, commercial, farm, and residential buildings, cooling unit in industrial, commercial, farm, and residential buildings, dock leveler for industrial and commercial buildings, hoist, lift, elevator, man lift, auto and truck lift, boat lift, boat hoist, conveyor used for industrial, agricultural, construction, and manufacturing assembly lines, irrigation device, water pump, feed conveyor, grain elevator, milking parlor, motor operated shutter for windows and doors, airplane hanger door, powered curtain, shade, drape used in residential, commercial and industrial applications, device for lifting, lowering, opening, and closing scenery in theaters of all types, and retractable screen for movie theaters, homes, offices, and displays.

9) The AC wireless switch of claim 1, wherein the AC power source is selected from the group consisting of a single-phase power, two-phase power, and three-phase power.

10) A method for wirelessly switching an AC powered device using the AC wireless switch of claim 1, comprising the steps of:
transmitting a first signal to activate the transmitter;
requesting to activate the AC powered device;
transmitting a second signal from the transmitter to the receiver wirelessly;
receiving the second signal by the receiver; and
enabling AC power to activate the AC powered device.

11) The method of claim 10, further comprising the steps of:
disabling the second signal once a request to deactivate the AC powered device is received; and
deactivating the AC powered device by disabling AC power to the device once the receiver stops receiving the second signal.

12) The method of claim 10, wherein the AC wireless switch can activate and deactivate the device selected from the group consisting of an exhaust fan, supply fan, ventilation fan, air circulating fan, blower, ceiling fan, kitchen ventilation fan, powered damper, liquid pump, gas pump, air pump, hydraulic pump, pneumatic pump, chemical pump, interior building light, exterior building light, street and highway light, landscape light, security light, parking lot and area light, emergency light, boat and ship dock light, horn, siren, aerator for lakes and ponds, driveway heater, heater in industrial, commercial, farm, and residential buildings, cooling unit in industrial, commercial, farm, and residential buildings, dock leveler for industrial and commercial buildings, hoist, lift, elevator, man lift, auto and truck lift, boat lift, boat hoist, conveyor used for industrial, agricultural, construction, and manufacturing assembly lines, irrigation device, water pump, feed conveyor, grain elevator, milking parlor, motor operated shutter for windows and doors, airplane hanger door, powered curtain, shade, drape used in residential, commercial and industrial applications, device for lifting, lowering, opening, and closing scenery in theaters of all types, and retractable screen for movie theaters, homes, offices, and displays.

13) The method of claim 10, wherein the receiver enables AC power to the AC powered device with the use of an electromagnetic relay.

14) The method of claim 10, wherein the second signal from the transmitter to the receiver is in the frequency range of 339 to 341 MHz.

15) The method of claim 10, wherein the transmitter is activated by a switch.

16) The method of claim 10, wherein the at least one switch sends the signal, requesting to activate the AC powered device.

17) The method of claim 11, wherein the at least one switch sends the signal, requesting to deactivate the AC powered device.

18) The method of claim 11, wherein the receiver disables AC power to the AC powered device with the use of an electromagnetic relay.

19) The method of claim 10, wherein the receiver enables single-phase AC power to the AC powered device.

20) The method of claim 10, wherein the receiver enables three-phase AC power to the AC powered device.
